(19) United States
(12) Patent Application Publication
(10) Pub. No.: US 2006/0002690 A1
(43) Pub. Date: Jan. 5, 2006

(54) Intelligent media splice

(75) Inventors: Peter M. Stwertka, Rochester, NY (US); Roger S. Kerr, Brockport, NY (US); James F. Greenlaw, Hamlin, NY (US); Aakash N. Mankani, West Henrietta, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/883,379

(22) Filed: Jul. 1, 2004

(51) Int. Cl. H04N 5/84

(52) U.S. Cl. 386/128

(57) ABSTRACT

A film splice (50) includes a memory (62) containing information about an attached film segment (70).

### FIELD OF THE INVENTION

The present invention relates to splicing of film media and more particularly relates to an apparatus and method whereby a memory is coupled with a film medium splice.

### BACKGROUND OF THE INVENTION

Referring to FIG. 1, there is shown, in block diagram form, a conventional workflow sequence for motion picture production. A motion picture film medium 12 is provided from a media manufacturer 10. Conventionally, motion picture film medium 12 is provided in lengths of several hundreds of feet, wound about a core 14. In preparation for production set 18, sections of unexposed motion picture film medium 12 are cut from the larger rolls and loaded into a film magazine 20 for exposure by a camera 22. Exposed medium 24 is then ready for processing by a lab 26.

Accompanying exposed medium 24 are written instructions 28 provided by various specialists in the production set 18 environment, working according to requirements and scene plans formulated beforehand in a preproduction activity 16. For example, camera 22 can have a crew of three or four members, some of which may provide some form of annotation or instructions for lab 26 or for an editing facility 30. The coupling of written instructions 28 to exposed medium 24 here and in subsequent treatment stages is fairly loose, provided primarily using adhesive labels or handwritten notes attached to film packaging.

Lab 26 performs any necessary processing needed to develop the image content of exposed medium 24. For conventional silver-halide-based film media, successive baths of developer, fixer, and bleach are used, as is well known in the imaging arts; however, lab 26 may also use thermal treatment or other techniques for developing the latent image to provide a developed medium 32 for an editing facility 30. At editing facility 30, developed medium 32 is edited to obtain the best “takes” of a studio session and to provide daily prints 36 or “dailies” as a type of proof for these takes. Editing facility 30 may use one or more scanners 34 and may even digitize complete scenes for editing and for adding digital effects, for example. The final masters 42 are provided as intermediates for mass reproduction of motion picture print films, which are the copies distributed to local theaters. Archival print films 38 are also produced and provided to an archival facility 40.

It must be emphasized that FIG. 1 and the above accompanying description are necessarily simplified in order to provide a broad overview of the motion picture workflow. However, a number of observations about motion picture film media workflow can be clearly made based on this high-level overview, including the following:
(i) Different organizations at different locations handle and process the film medium. Maintaining clear communication between these organizations and tracking the progress of film media through each stage can be fairly complex.
(ii) Each organization handling the film medium has some type of tracking system, such as for billing purposes, for example. There have been some attempts to standardize information stored about the film medium at any point in the workflow; however, no widely accepted standards have been implemented.
(iii) Communication difficulties abound. There can be considerable information available, for example, from the studio production team that are currently recorded manually. Chances are high that much of the available information that could be helpful to skilled workers at editing facility 30 would be lost or that partial information would be confusing.

Not as apparent from the description accompanying FIG. 1, but well known to workers in the motion picture production environment are other problems, such as the following:
(a) The shooting environment of production set 18 is highly complex and involves the activities of a substantial number of skilled workers in different disciplines. These disciplines include camera crews, lighting personnel, audio personnel, stagehands, makeup and hair stylists, actors, stunt performers, and direction and production personnel. For a particular scene take, there can be a considerable body of information of value to those who work in either lab 26 or editing facility 30. However, in conventional practice, abbreviated instructions from production set 18 personnel or from preproduction activity 16 are typically given on forms that accompany developed medium 32 to editing facility 30. There is very little accommodation for special information that may be helpful for lab 26 or for editing personnel. For example, an instruction to defer a processing step at lab 26 may be provided in comments from production set 18 personnel and can easily be lost or forgotten.
(b) The environment of production set 18 is hectic, particularly during shooting of a scene. Film magazines 20 are loaded and unloaded from camera 22 at a rapid pace, with annotations manually made for each scene take on a particular length of film and for identifying “circle takes”, that is, scene takes that are agreed to have gone well and are intended for production in daily prints 36. Film usage is tracked, so that waste film is accounted for and unused film left in film magazine 20 can be reused or resold.
(c) Creative intent of various skilled workers can be important to an understanding of later handling of exposed medium 24, developed medium 32, daily print 36, master 42, and archival print 38. Using conventional methods, however, there is little or no facility for recording information that is not expressible in measurable units.
(d) Video content for any particular length of exposed medium 24, developed medium 32, daily print 36, master 42, print film, or archival print 38 is described on paper or in a database. However, there is no type of easily viewable pictorial representation or index accompanying a length of film that would enable easy identification of the content.

In light of the above observations (i)-(iii) and problems (a)-(d), it can be seen that there is considerable value in reliably coupling information to the motion picture film in its various production and processing stages. In particular, there is considerable value in methods that make information about earlier production steps available to workers who perform subsequent production steps. Further, there might be reasons for making information available in a selective manner, so that, for example, lab 26 may not have access to all of the information about a length of film that was provided at production set 18; however, editing facility 30 may have access to all of the data from both production set 18 and lab 26.

One notable problem with the conventional workflow of FIG. 1 relates to the interaction, at editing facility 30, of scene content that is provided on conventional motion picture film with electronically generated and manipulated scene content. Much of the editing performed on a motion picture scene can be executed on a digitally scanned version of the scene content. After this treatment, the completed scene is then imaged back onto motion picture film, to be provided as daily prints 36 and as masters 42. Using conventional handwritten notation and manual techniques for associating information about the scene with the scene itself, it is difficult to incorporate information about the scene into the digital image data stream. Written documentation must accompany film that leaves editing facility 30; if this documentation is inadvertently separated from the film, the job of determining what scene content is on an individual reel can be a tedious and costly task.

A number of types of memory devices can be coupled to a specific length of motion picture film. Examples of suitable memory devices include bar code labels or other optically encoded devices and magnetic strips or similar magnetically encoded media. RF ID devices offer yet another type of solution for associating a memory storage device with a unit of a consumable imaging medium. RF ID tags have been proposed for use in a wide range of identification and tracking applications, such as with passports and credit cards, as is disclosed in U.S. Pat. No. 5,528,222 to Moskowitz et al. One type of commercially available, low profile RF ID tag is the “TAG-IT INLAY”™ RFID tag available from Texas Instruments, Incorporated, located in Dallas, Tex., USA. This component can be used to provide identifying information about an item to which it is attached, for example. RF ID devices are useful for tracking the location of, characteristics of and usage of documents, books, packages, and other inventory. For example, RF ID tags can be used to track the location of documents and track the chain of custody of such documents within a document management system. RF ID tags offer the advantage of small size, enabling these devices to be unobtrusively attached or hidden within an item. Unlike optical or mechanical equivalents, RF ID tags allow communication regardless of orientation relative to a transceiver. Equipped with an on-board read-write memory, these devices can be used for recording and recall of at least some amount of data related to an item to which they are coupled.

Systems employing RF ID tags typically comprise a read/write element, or RF transceiver, that acts as the interface between the RF ID tag and a computer system of some type that uses and/or provides the stored data. The RF ID tag itself is typically embodied as a transponder, having an integral antenna, adapted to send and receive electromagnetic fields in cooperation with the transceiver, where the electromagnetic field itself contains information to be conveyed to and from a memory on the RF ID tag. Both read/write and read-only versions of RF ID tag are available. Information that is stored in memory on the RFID tag can be used to track, identify, and process an item. The RFID tag memory can also store other information that is to be associated with the item, such as timestamps and vendor identification codes for example.

Commonly assigned U.S. Pat. No. 6,247,857, “Multistage System for Processing Photographic Film” (Wheeler et al.), incorporated herein by reference, discloses the use of an RF ID tag coupled with a memory for tracking the treatment of photographic film throughout the basic multi-stage motion picture film production workflow. In the Wheeler et al. patent, methods for core-to-core transfer of data are disclosed, so that, for a given process such as film exposure, development, or telecine transfer, input data is read from an RF transponder on an input core. This input data is then processed, supplemented with any suitable information for the corresponding motion picture film processing, and rewritten to an RF transponder on an output core. While the system and methods of the Wheeler et al. patent provide a useful mechanism for tracking the processing status for a complete roll of motion picture film medium at each treatment stage, there are inherent limitations to this approach where splices are used to join separate lengths of film.

Splicing techniques are widely used during various stages of motion picture film production and presentation. Referring back to FIG. 1, before or during lab 26 processing, one or more splices may be applied to join lengths of film from different cameras 22. Splices are also widely used to join different segments of processed film that are handled by editing facility 30. A roll of film provided from editing facility 30, such as daily print 36, may have multiple splices, one preceding each scene, for example. As the editing team works with the film, adding effects and coordinating audio tracks, splices may be applied to join lengths of edited film for proofs used to create master 42.

Splices themselves may be formed using tape or using a combination of ultrasonic welding techniques, heat, and adhesive cement. In general, splices are avoided within a master film and within high-quality print films; however, on dailies and other types of proofs and intermediates from the editing process, splices are often used. Even at the motion picture theater, conventional practices may require the projection staff to splice together feature and trailer films in preparation for the film showing.

At many stages of production, spliced film requires some form of labeling and documentation, so that the film contents can be identified. Since conventional procedures for documenting which lengths of film are spliced into what roll are largely manual, there is significant opportunity for error. It can be appreciated that there is a recognized need for more automated methods for splice detection and for obtaining information on film contained in a spliced length. There would be particular advantages to a method that allowed access to information on any of a number of splices in a roll of film. An ability to automatically detect splices and identify the related visual content can save time and expense during many stages of the production cycle, including audio synchronization, content manipulation and editing, and archival.

### SUMMARY OF THE INVENTION

It is an object of the present invention to provide identifying information to accompany a recordable medium by coupling a memory with a spliced segment of film medium. With this object in mind, the present invention provides a film splice comprising a memory.

From another aspect, the present invention provides a method for coupling a memory onto a segment of a recordable film medium comprising the step of affixing a splice onto the segment, wherein the splice comprises an addressable memory.

It is a feature of the present invention that the splice itself comprise a memory having encoded information thereon about a segment of recordable film medium to which the splice is affixed. The memory may itself contain all necessary information about the spliced segment, or may comprise an electronic address for accessing information about the spliced segment.

It is an advantage of the present invention that it allows a separate memory to accompany each spliced segment of recordable film medium, so that any number of spliced segments can be provided in a roll of recordable film medium.

It is an advantage of the preferred embodiment of the present invention that it allows access to information about a spliced segment of recordable film medium without the need to unravel a roll of film medium containing the spliced segment.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a block diagram showing conventional workflow stages for motion picture film production.

FIG. 2 is a plane view showing a splicing element comprising a memory, according to one embodiment of the present invention.

FIG. 3 is a plane view showing a splice comprising a memory attached to two film segments.

FIG. 4 is a side view of a roll of film medium comprising a plurality of splices.

FIG. 5 is a block diagram showing an arrangement of components for accessing a coupled memory on a splice according to the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

The following description of the present invention is directed primarily to supporting the transfer of data for various operations performed upon a film medium used for motion pictures, due to the complex nature of the film production workflow and to the number of different facilities and functions that have a role in this workflow. However, it must be noted that the methods and apparatus of the present invention could be more broadly applied to any type of recordable film medium that, as it proceeds through a treatment or set of operations, is wrapped about itself, such as on a film core or in a reel, for example. Other types of film media to which the present invention could be applied also include photographic negative film or wound photographic paper, as well as magnetic tape media, for example.

For an understanding of the description that follows, it is instructive to note the broad use of the term “coupled” as used herein, as distinguished from the understanding of this term as used in prior art. In prior art embodiments, such as the in RF ID embodiment noted in the background with respect to U.S. Pat. No. 6,247,857, a memory itself is coupled to a length of motion picture film by physical attachment to film core 14. That is, coupling is achieved by direct attachment of a device containing the memory, such as an RF transponder. However, this type of coupling may provide limited memory capacity and is not readily adaptable for identifying spliced film segments.

The term “memory” is used in a broad context within this disclosure, to indicate a suitable type of data storage mechanism, which can include solid-state memory devices, magnetic storage devices including magnetic disks, or optical storage devices, for example. Memory can be volatile or non-volatile, or can include both volatile and non-volatile components.

Referring to FIG. 2, there is shown a splicing element 60 of a preferred embodiment of the present invention. Provided on a flexible, adhesive substrate 66, such as a polymer tape, this type of RFID transponder can be provided in ultra-thin versions, such as are used in ID cards, luggage devices, and merchandising applications, for example. An RFID transponder of this type is disclosed in U.S. Pat. No. 5,574,470 (de Vall). This type of RFID transponder is available on a reel, in a peel-and-stick configuration. TAG-IT Inlays from Texas Instruments, Dallas, Tex., are one familiar product line providing this type of RFID transponder. The self-adhesive capability of the Tag-It inlay is particularly attractive for application as splicing element 60. A low-profile RFID transponder of this type can be unobtrusively attached at each splice location, without causing damage to a recording film medium or to its image quality.

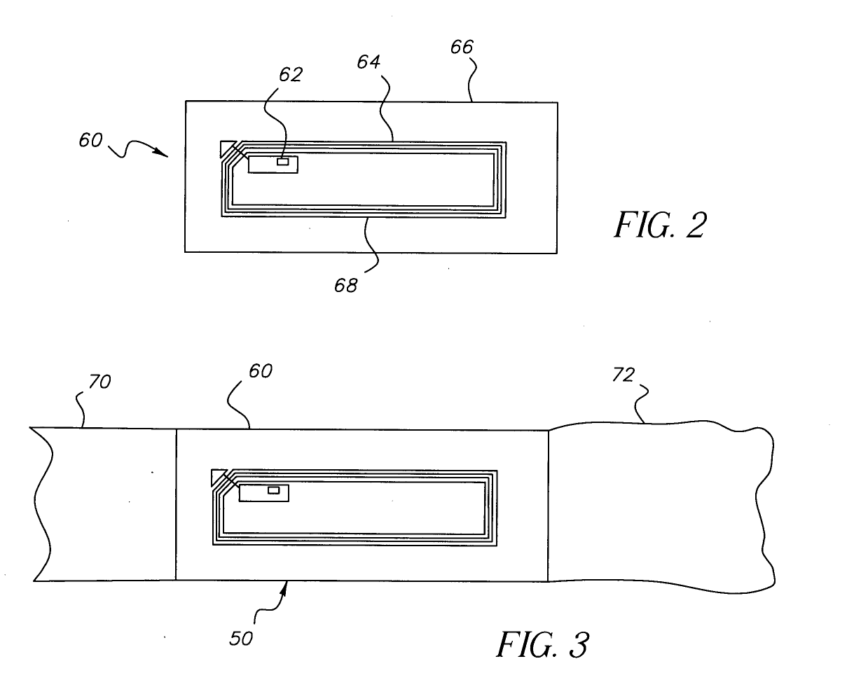

Referring to FIG. 3, there is shown a splice 50 comprising splicing element 60 used to splice together film segments 70 and 72. Splicing element 60 can be adhesively attached to provide a continuous scene sequence through splice 50 or may join film segments 70 and 72 at a break between scenes.

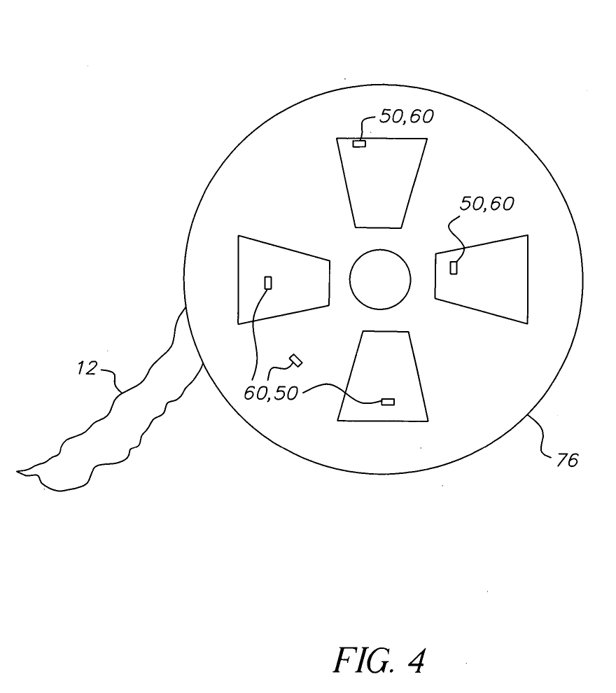

Referring to FIG. 4, there is shown a reel 76 of wound motion picture film 12 having a number of splices 50 using splicing elements 60. Low-profile components, such as the TAG-IT devices noted above, allow wrapping of film 12 without noticeable impact on image quality.

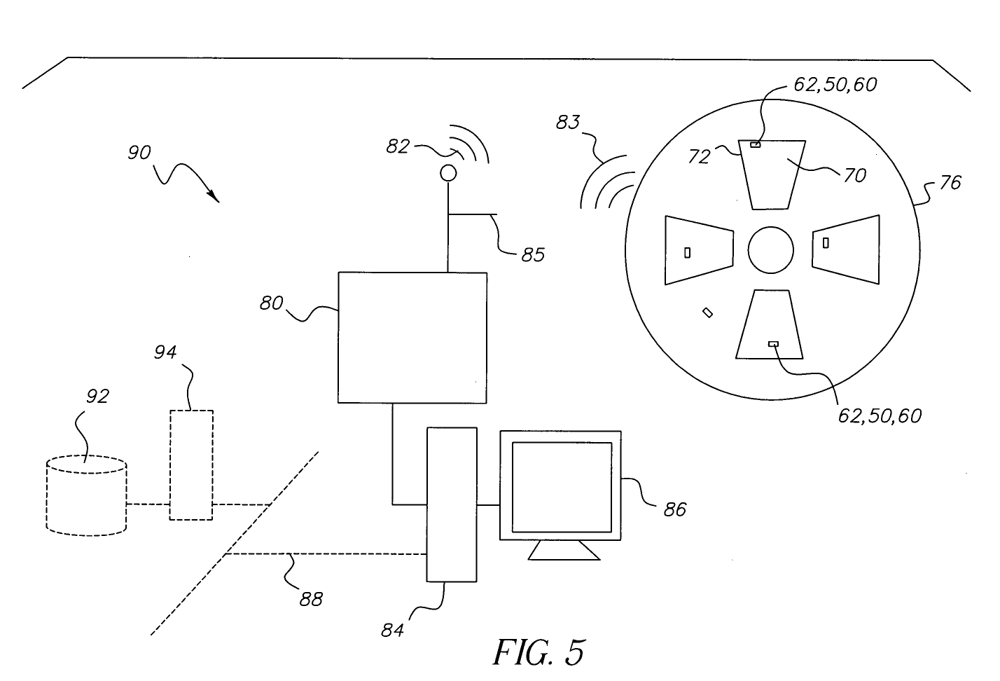

Referring to FIG. 5, there is shown a system 90 for obtaining information stored in memory 62 corresponding to one or more splices 50. In an electromagnetic embodiment, splicing elements 60 are RF ID tags, as described in the background section above. Interface component 80 is an RF transceiver, which communicates with splicing elements 60 by transmitting a first frequency as an electromagnetic field 82 and receiving, in response, a second frequency as an electromagnetic field 83 having encoded data content. In one embodiment, for example, the transceiver used as interface component 80 is a “Model S2000”™ transceiver, available from Texas Instruments, Incorporated, located in Dallas, Tex., USA. Alternatively, the transceiver may be a “Model U2270B”™ transceiver, available from Vishay-Telefunken Semiconductors, Incorporated, located in Malvern, Pa., USA. An antenna 85 is disposed so as to be in a suitable position for reading the transponder that serves as splicing element 60. By way of example, and not by way of limitation, Table 1 lists a number of types of splicing elements 60 that could be used, with a corresponding type of interface component 80 for each type. Interface component 80 connects with a workstation 84, or similar control logic device, and an optional display 86 for monitoring stored data content and for accepting operator commands to read from memory 62 at one or more splicing elements 60. Splicing elements 60 are uniquely addressable from interface component 80.

System 90 may read and, optionally, write to memory 62 stored solely on one or more splicing elements 60. Alternately, information corresponding to splicing element 62 may be stored within an external memory 92 accessed through a networked server 94, which may be remotely located on a network 88. In this case, memory 62 on splicing element 60 contains a pointer to an address on external memory 92. This networked arrangement allows storage of a considerable amount of data for each splice 50, well in excess of the typical storage capacity of splicing element 60 devices that are currently available.

In a “read-only” embodiment, workstation 84 may not write any new data to memory 62 on splicing element 60, but may merely record data at the appropriate location in networked external memory 92. With such an embodiment, it would not be necessary for interface component 80 to have full read/write capability; instead, it would be sufficient to have each splicing element 60 be uniquely encoded, so that film segments 70, 72 are thereby uniquely identified. The job of tracking each unique encoding would be performed using external memory 92.

TABLE 1
Exemplary Listing of Splicing Element 60
And Corresponding Interface Component 80

| Where splicing | Corresponding interface component 80 |
|---|---|
| element 60 comprises: | would be: |
| Bar code, or other | Bar code reader or other optical reader, |
| optically encoded | with an optional printer for writing |
| representation | updated information to a bar code label. |
| Magnetically encoded strip | Magnetic strip reader, with an optional |
| | write head for recording updated data. |
| Transponder, such as | Transceiver, such as an RF transceiver for |
| an RF transponder. | reading and, optionally, writing to an RF |
| | transponder. |

Information Stored in Coupled Memory 62 for Film Segment 70

By way of example, and not by way of limitation, Table 2 lists some of the metadata available from media manufacturer 10 for storing in memory 62 that is coupled to film segment 70 for newly manufactured motion picture film 12.

Information Stored in Coupled Memory 62 from Production Set 18

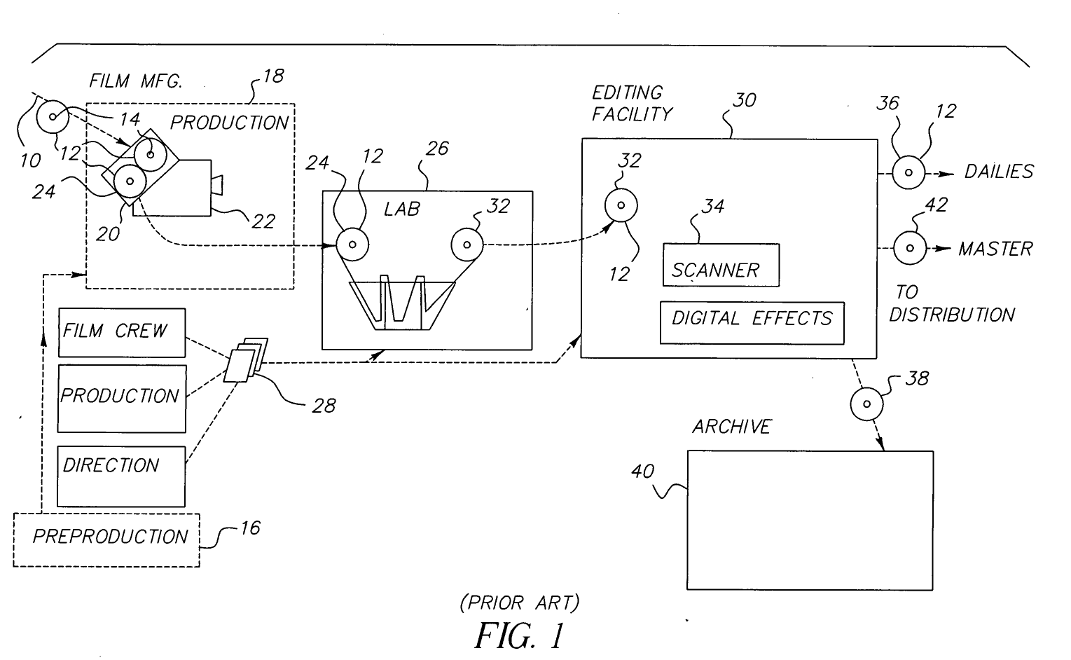

As was shown in FIG. 1, there is a considerable amount of valuable information about a film shooting recorded at production set 18. This includes both information from camera 22 and information from production teams involved with sound, lighting, special effects, makeup and costuming, and direction, for example. By way of example, and not by way of limitation, Table 3 lists some of the metadata available from studio personnel at production set 18 that can be coupled to film segment 70 using memory 62.

TABLE 2
Example Metadata Provided by Media Manufacturer 10

| Metadata | Description |
|---|---|
| Manufacture date | Time stamp for date of media segment |
| | manufacture. |
| | Example: 020203143406GST |
| Emulsion batch identifier | Unique identifier for film emulsion. |
| | Manufacturer data. Example format: |
| | emulsion_id - roll# -slit_part# - strip# - |
| | perf_unit# |
| | Example: 2383-101-011-unit-01-01.1 |
| Film type | Product name and catalog number for film |
| | medium. |
| | Example: Type 1351B Negative Film |
| Sensitometric characteristics | Data for sensitometric response of batch |
| | of media. |
| | Example: Density values related to log of |
| | exposure levels. |

TABLE 3
Example Metadata Added at Production Set 18

| Metadata | Description |
|---|---|
| Date and time stamp | Date film segment 70 was exposed, starting |
| | time and ending time. |
| | Example: |
| | 12 Feb. 2002;13:45:23;13:48:18 |
| Studio number | Identification of studio using the film. |
| | Example: Studio 112C |
| Name of production | Name of overall film production. |
| | Example: Seargeant Bulfinch |
| Camera crew name(s) | Identification of camera team. |
| | Example: J. Borlad, camera; E. Zales, |
| | asst., T. Torba, 3^{rd} |
| Camera identification | Make, model, identifier of camera 22. |
| | Ex. A model, 2349 type, S/N |
| | 3002093992093 |
| Lighting conditions | Description of overall light conditions at |
| | shooting for segment 70. |
| | Ex. Daylight, outdoors. |
| Camera settings | Adjustments made to camera for each |
| | segment 70. |
| | Example: Focus at 12; speed 16 |
| Scene number | Identification of the scenes on a particular |
| | segment 70 of exposed film. |
| | Example: 11, 12/B, 15, 23, 28X, 28A |
| Take identifier | Identification of the “take” exposed for |
| | each scene. |
| | Example: Scene 23, takes 1,2,3,4. |
| Job number | Internal number for shooting. |
| | Example: 12998 |
| Director name | Identification of director for each scene. |
| | Example: J. Ziffrin |
| Actor(s) name(s) | Identification of talent appearing in |
| | segment 70. |
| | Example: A. Arhur; B. Gurnish; Bobo, |
| | chimp. |
| Film magazine number | Identifiers for film magazines used. |
| | Example: Mag.AU33404004 |
| Film roll number | Identifier provided by manufacturer. |
| | Example. 10022002DEC8848 |
| Audio crew names | Names of audio crew members at the shoot. |
| | Example: HGHunt; KKosmanos |
| Start and end | Markers indicating the beginning and |
| synchronization | ending of each segment 70. |
| for each take | |
| Remarks on scene content | Remarks from production set 18 crew. |
| | Example: Scene 13 audio muted. |
| Instructions for | Comments useful to lab 26. |
| lab processing | Example: Bright flash at 2365. |
| Instructions for editing | Comments useful to editing facility 30. |
| | Example: Horsefly in scene at 3452. |
| Instructions for archival | Comments useful for archive 40. |
| | Example: Deliberately dimmed light for |
| | scene 5. |

Audio synchronization information can also be stored in coupled memory 62 for film segment 70. Conventional methods synchronize audio on production set 18 using a clapboard. At editing facility 30, developed medium 32 is manually scanned in order to locate the clapboard indicating the beginning of each scene, so that synchronization with taped audio content can be performed. Using coupled memory 62, however, eliminates the need for manually searching for the clapboard image. Instead, camera 22 can simply record and store start and end data for each segment 70, allowing automation of this synchronization activity.

Among the data storage capabilities of networked memory 92 on networked server 94 is the ability to store audio content corresponding to film segment 70. While the audio content from a film shooting travels to editing facility 30 by a separate path for incorporation of the soundtrack, there can be considerable value in storing the audio content for film segment 70 in a memory 62 coupled to that length of film segment 70. While it would be possible to store all of the audio content in memory 62 on splicing element 60, other arrangements may be more practical and require less memory 62 storage. For example, a low-resolution copy of audio could be stored for scene takes on film segment 70. As another example, audio data storage could be used for recording comments by the director or by members of the crew for camera 22 or other production teams. Such verbal instructions could be of value for the work performed in editing facility 30, for example. Where coupled memory 62 is stored on a separate networked server 94, the complete audio content of a film shooting could be stored and associated with film segment 70 using splicing element 60.

Information Stored in Coupled Memory 62 by Lab 26

As was described with reference to FIG. 1, lab 26 processes film segment 70 in order to provide developed medium 32 that contains the image content for the scene takes that are on the length of motion picture film medium 12. Conditions that affect how the processes at lab 26 are executed include the type of film provided as film segment 70, special instructions from media manufacturer 10 and from production set 18, if any. These conditions can impact process variables such as timing, temperature, chemicals used, procedures followed or omitted, and drying methods, for example. By way of example, and not by way of limitation, Table 4 lists some of the metadata available from lab 26 for storing in networked memory 62.

TABLE 4
Example Metadata Added by Lab 26

| Metadata | Description |
|---|---|
| Date and time stamp | Date developed, starting time and ending |
| | time. |
| | Example: |
| | 12 Feb. 2002;13:45:23;13:48:18 |
| Lab identifier | Identification of lab that processed the film. |
| | Example: MaxColorLab, OremUT 80976- |
| | 578575 |
| Name of production | Name of overall film production. |
| | Example: Seargent Bulfinch |
| Chemical process used | Description of chemicals used for |
| | developing the image on film segment 70. |
| | Example: Bleach: A3456; Developer: |
| | R43; Fixer: 19765345 |
| Temperature | Temperature of tank or drying temperature. |
| | Example: Drying: 120 deg. F. |
| Timing | Timing sequence used. |
| | Example: Bleach: 12 sec.; Developer: 28 |
| | sec; Fixer 22.4 sec. |
| Length | Lengths of film developed and unused. |
| | Example: Used: 250 ft.; Recovered: 135 |
| | ft. |
| | Waste: 18 ft. |
| Printed takes | Identification of scene takes printed. |
| | Example: Scene 3, Take 2; Scene 11, |
| | Take 1; Scene 12, Takes 2 and 3. |

Information Stored in Coupled Memory 62 by Editing Facility 30

As was described with reference to FIG. 1, operations performed at editing facility 30 involve a considerable range of tools and talents. The functions performed involve not only straightforward cut-and-splice editing for selecting desired content and eliminating unwanted content, but also include sophisticated operations for adding special effects, soundtrack synchronization, and retouching, for example. It can be appreciated that the personnel involved in this phase of motion picture film medium 12 preparation can benefit significantly from information and instructions provided by personnel at production set 18 and lab 26. In addition, specialists at editing facility 30 can also provide useful information on the processes they perform. By way of example, and not by way of limitation, Table 5 lists some of the metadata available from editing facility 30 for storing in networked memory 62.

TABLE 5
Example Metadata Added by Editing Facility 30

| Metadata | Description |
|---|---|
| Date and time data | Dates and times of editing operations |
| | performed. |
| | Example: Scene 11, take 2. Retouch |
| | 030203, 10:52-14:28. J. HJ |
| | Digital effects: 030303-030403 by |
| | AUS34222 |
| | Soundtrack synch annotation: |
| | 79588903A12 |
| | Master ready: 042303 182345 |
| Names of editing specialists | Names of persons or organizations |
| | performing each operation. |
| | Example: Edit coord. J. Thompson |
| | Retouch: FFortney Labs |
| | Dig Effects: GNHLtd. |
| Scenes | For daily prints 36, listing of scenes |
| | provided. |
| | Example: Scenes 1,4,17,23 |
| Equipment Used | Identification of systems utilized |
| | Example: Editor SNX9980J |

Data Flow and Networking

As is shown in the above description, particularly with reference to Tables 2-5, each successive operation performed on film segment 70 can provide data that is useful to those who perform subsequent operations. Thus, for example, with reference to FIG. 1, information from production set 18 is helpful for providing suitable development processing at lab 26. Information from both production set 18 and lab 26 is helpful to specialists at editing facility 30. To support efficient and high-quality output from motion picture film medium 12, the method of the present invention provides a way to make media and processing information available, as needed, for each treatment step in the motion picture film medium 12 workflow.

Splicing element 60, uniquely encoded for a specific film segment 70, facilitates the logical coupling of film segment 70 content to a location in networked memory 92. Optionally, some information can also be stored within memory 62 on splicing element 60. To access the stored data in coupled network memory 92, workstation 84, or other control logic processor, cooperates with interface component 80 to obtain the encoded address data from splicing element 60. Once this information is obtained, workstation 84 transmits an instruction or request, incorporating this address, over network 88. Along with the address, workstation 84 may also be required to provide authentication and password data to enable access. The complete instruction to memory 92 may be in proprietary format or may be in the form of a standard network request such as an HTTP (Hypertext Transfer Protocol) request, similar to that used for Internet browsers, or an SQL instruction, such as those used for database queries, for example. A database system, such as a database server available from ORACLE Corporation, could be used for networked memory 92.

Throughout processing of film segment 70, one or more networked memories 92 may be employed. Any number of alternate arrangements are possible, including the use of a single networked server 94 for one or more operations or of shared resources between any two or more operations. Similarly, it may be possible to store some portion or all of memory 62 on different servers or workstations. Alternative embodiments, in which networked memory 92 is stored differently during different operations, may also have advantages. For example, lab 26 may not provide connection to a remote database server connected as networked server 94, but may only obtain and provide information by reading from and writing to an RF ID transceiver that serves as splicing element 60 having an integral memory 62 with just enough data capacity for lab 26 operations. In this way, there may be enough information shared with lab 26 for performing the function of developing film segment 70 to provide developed medium 32, without requiring on-line connection of lab 26 with networked server 94.

There may be reasons for allowing only partial contents of networked memory 92 to be shared with a facility that performs any one function. For example, it may not be desirable to provide lab 26 staff with access to all information generated at production set 18. Much of the information may be superfluous, while some information may be sensitive. The method of the present invention allows partial disclosure of stored data in coupled memory 62 or 92, using conventional techniques for protected access to selective data, as are well known in the database and information technology arts. Thus, for example, the password assigned to lab 26 might have specific permission for access to some data contents of networked memory 92, but not to other contents.

Information stored in networked memory 92 can be used in conjunction with other software applications running on networked server 94 or on workstation 84 or other control logic processor. Different operations within production set 18, lab 26, editing facility 30, or elswhere can be modified, optimized, or even disabled based on this stored information.

It can be appreciated that there would be advantages in providing a networked storage solution, such as is illustrated in FIG. 5. Access to one or more devices providing networked memory 92 would allow participants in the film workflow for film segment 70 to have access to the appropriate data for each operation. This arrangement would help to reduce confusion about how a particular film segment 70 has been treated at any point in the workflow and, for supervisory management tracking, would help to provide status information readily available on work in process. Archival prints 38 would have associated data stored in coupled memory 62 or 92, accessible for facilitating re-use of scene content or re-working of a motion picture film following its initial launch, for example.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, there can be additional metadata stored in memory 62 to support accounting and tracking functions. The present invention can be used with any number of different types of networks 88, including local- or wide-area networks, using suitable standard protocols such as ethernet or Token Ring, or using proprietary protocols. The present invention can be used with any of a number of types of recordable film media, including negative and positive films and magnetic film media, for example.

Thus, what is provided is a method for coupling data to a splice for a segment of recordable film media.

What is claimed is:

1. A film splice comprising a memory.

2. A film splice according to claim 1 wherein said memory is accessed using an electromagnetic signal.

3. A film splice according to claim 1 wherein said memory is provided on a flexible substrate.

4. A film splice according to claim 1 wherein said memory comprises a pointer for memory access by a networked server.

5. A film splice according to claim 3 wherein said flexible substrate is adhesive.

6. A film splice according to claim 1 wherein said electromagnetic signal is an RF signal.

7. A film splice according to claim 1 wherein said memory comprises a bar code.

8. A film splice according to claim 1 wherein said memory comprises an optical encoding.

9. A system for coupling information to a segment of a recordable film medium, the system comprising:
(a) a splice element affixed to the segment of recordable film medium at a splice, said splice element comprising:
(i) a memory component comprising encoded data;
(ii) a transponder for accepting a first signal and providing a second signal in response, said second signal conditioned by said encoded data;
(b) an interface component for transmitting said first signal and receiving said second signal from said transponder;
(c) a control logic processor for providing control commands to said interface component.

10. A system for coupling information to a segment of a recordable film medium according to claim 9, further comprising
(d) a networked server communicating with said control logic processor over a network, said networked server further coupled to a memory for storing information about the segment of recordable film medium.

11. A method for coupling a memory onto a segment of a recordable film medium comprising the step of affixing a splice onto the segment, wherein the splice comprises an addressable memory.

12. A method for coupling a memory onto a segment of a recordable film medium according to claim 11 further comprising the step of transmitting an electromagnetic signal for addressing said addressable memory
